(19) United States
(12) Patent Application Publication
(10) Pub. No.: US 2025/0373765 A1
(43) Pub. Date: Dec. 4, 2025

(54) METHOD FOR DETERMINING PROJECTION REGION WHERE IMAGE IS PROJECTED, AND PROJECTION APPARATUS

(71) Applicant: SEIKO EPSON CORPORATION, Tokyo (JP)

(72) Inventors: Kota TAKEUCHI, Azumino-shi (JP); Yutaro Iijima, Matsumoto-shi (JP)

(73) Assignee: SEIKO EPSON CORPORATION, Tokyo (JP)

(21) Appl. No.: 19/219,027

(22) Filed: May 27, 2025

(30) Foreign Application Priority Data
May 28, 2024 (JP) 2024-086099

(51) Int. Cl. H04N 9/31

(52) U.S. Cl. CPC H04N 9/3185; H04N 9/3188

(57) ABSTRACT

A method for determining a projection region including identifying the coordinates that are in a screen coordinate system, for each of four vertices corresponding in a one-to-one relationship to four vertices of a rectangle that defines a drawing region of a panel, the screen coordinate system of a projection surface; identifying first intersection coordinates that are in the screen coordinate system and that are coordinates of a first intersection where the two diagonals of a quadrangle corresponding to the first quadrangle; identifying as a first rectangle a largest rectangle that falls within the quadrangle, has a center at the first intersection coordinates, and has a first aspect ratio; and determining the projection region of the projection surface based on the first rectangle.

The present application is based on, and claims priority from JP Application Serial Number 2024-086099, filed May 28, 2024, the disclosure of which is hereby incorporated by reference herein in its entirety.

### BACKGROUND

### 1. Technical Field

The present disclosure relates to a method for determining a projection region where an image is projected, and a projection apparatus.

### 2. Related Art

Projectors each include, for example, a panel having a drawing region in which multiple pixels that output light based on an image signal are arranged. A projector of this type projects an image drawn in the drawing region of the panel onto a projection surface. In the technical field of projectors, there is a known technology for correcting distortion of an image to be projected and projecting the corrected image. For example, JP-A-2010-259082 discloses a trapezoidal distortion correction method capable of projecting an image or the like having a uniform pattern in the rightward-leftward direction with the pattern not distorted in the projected image.

JP-A-2010-259082 is an example of the related art.

In the correction method of the related art, however, the largest possible drawing region of the panel provided in the projector may not be allowed to be used for the image after the distortion correction. It is therefore desired to determine an image projection region of the projection surface in such a way that the drawing region of the panel provided in the projector can be effectively used.

### SUMMARY

To achieve the object described above, a method for determining a projection region according to an aspect of the present disclosure is a method for determining a projection region in which an image drawn in a drawing region of a panel disposed in a projection apparatus is projected, the method including: identifying coordinates that are in a first coordinate system, for each of four vertices of a first quadrangle that defines the drawing region in a coordinate system of the panel, the first coordinate system being a coordinate system of a projection surface on which the image is projected and which is viewed in a direction of a normal to the projection surface; identifying first intersection coordinates that are in the first coordinate system and that are coordinates of a point where two diagonals of a second quadrangle intersect with each other, based on coordinates for each of four vertices of the second quadrangle, the second quadrangle corresponding to the first quadrangle, and the four vertices of the second quadrangle corresponding in a one-to-one relationship to the four vertices of the first quadrangle; identifying as a first rectangle a largest rectangle that falls within the second quadrangle, has central coordinates equal to the first intersection coordinates, and has a first aspect ratio; and determining the projection region of the projection surface based on the first rectangle.

A projection apparatus according to another aspect of the present disclosure, includes a panel having a drawing region in which an image is drawn; and a processing circuit, the processing circuit is configured to identify coordinates that are in a first coordinate system, for each of four vertices of a first quadrangle that defines the drawing region in a coordinate system of the panel the first coordinate system being a coordinate system of a projection surface on which the image is projected and which is viewed in a direction of a normal to the projection surface; identify first intersection coordinates that are in the first coordinate system and that are coordinates, of a point where two diagonals of a second quadrangle intersect with each other, based on coordinates for each of four vertices of the second quadrangle, the second quadrangle corresponding to the first quadrangle, and the four vertices of the second quadrangle corresponding in a one-to-one relationship to the four vertices of the first quadrangle; identify as a first rectangle a largest rectangle that falls within the second quadrangle, has central coordinates equal to the first intersection coordinates, and has a first aspect ratio; and determine a projection region of the projection surface based on the first rectangle, the projection region being a region where the image is projected.

### BRIEF DESCRIPTION OF THE DRAWINGS

FIG. 1 schematically shows a system including a projector according to an embodiment of the present disclosure.

FIG. 2 is a block diagram showing the configuration of the projector.

FIG. 3 is a descriptive diagram for illustrating an example of a method for calculating a conversion matrix used to perform conversion from a panel coordinate system into a screen coordinate system.

FIG. 4 is a descriptive diagram for illustrating a method for identifying the coordinates, in the screen coordinate system ES, of four vertices on a projection surface that correspond in one-to-one relationship to four vertices on a panel.

FIG. 5 is a descriptive diagram for illustrating the operation of an intersection coordinate identification section.

FIG. 6 is a descriptive diagram for illustrating an example of a method for identifying a first rectangle.

FIG. 7 is a descriptive diagram for illustrating the remaining portion of the method for identifying the first rectangle.

FIG. 8 is a descriptive diagram for illustrating an example of a method for identifying a second rectangle.

FIG. 9 is a descriptive diagram for illustrating the remaining portion of the method for identifying the second rectangle.

FIG. 10 is a descriptive diagram for illustrating a method for identifying a drawing region of the panel after correction.

FIG. 11 is a flowchart showing an example of the operation of the projector.

### DESCRIPTION OF EMBODIMENTS

An embodiment for implementing the present disclosure will be described below with reference to the drawings. Note, however, that dimensions and scales of portions in the drawings are made different from actual ones as appropriate. Furthermore, the following embodiment is a preferable specific example of the present disclosure, and various technically preferable limitations are therefore imposed thereon, but the scope of the present disclosure is not limited to the embodiment unless the following description has a description stating that the present disclosure is particularly limited thereto.

### 1. EMBODIMENT

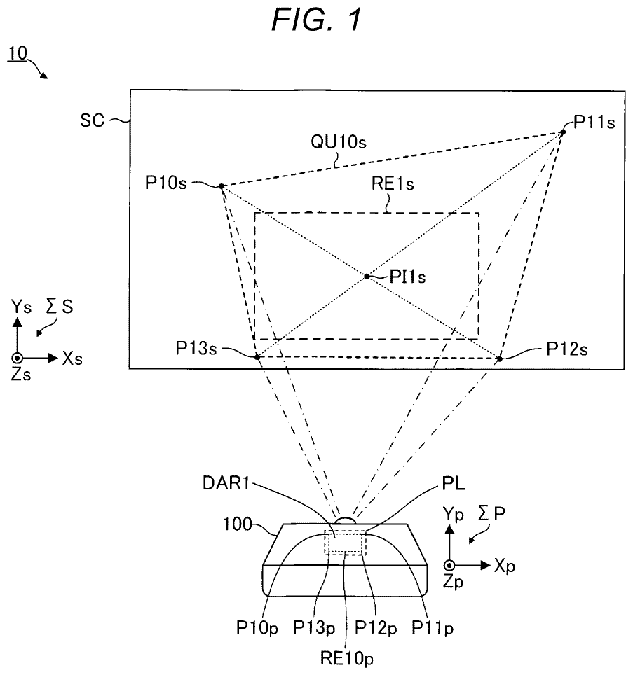

In the present embodiment, a projection apparatus will be described with reference to a projector that projects an image onto a projection surface. A system 10 including a projector 100 according to the embodiment will first be schematically described with reference to FIG. 1.

FIG. 1 schematically shows the system 10 including the projector 100 according to the embodiment of the present disclosure.

The projector 100 includes a panel PL having a drawing region DAR1, in which an image based on image data output from an instrument that is not shown, such as a computer, is drawn. The projector 100 projects the image drawn in the drawing region DAR1 of the panel PL onto a projection surface SC. Note that the panel PL is, for example, an electro-optical panel such as a transmissive liquid crystal panel, a reflective liquid crystal panel, or a digital mirror device. It is assumed in the present embodiment that three panels PL corresponding to red, green, and blue are provided. The drawing region DAR1 of each of the panels PL includes multiple pixels arranged, for example, in a matrix. It is assumed in the present embodiment that the drawing region DAR1 is the largest drawing region of the panel PL. It is further assumed in the present embodiment that a quadrangle that defines the drawing region DAR1 of the panel PL is a rectangle RE10p. That is, it is assumed in the present embodiment that the drawing region DAR1 is a rectangular drawing region. The quadrangle that defines the drawing region DAR1 is, however, not limited to a rectangle. The rectangle RE10p defines a drawing region DAR1 of the panel PL in a panel coordinate system CP. The rectangle RE10p is an example of “a first quadrangle”. The projection surface SC, on which an image is projected, is a surface of an object such as a screen, and is generally a planar surface. The projection surface SC may not be a planar surface in a strict sense, but is preferably a surface that can be regarded as a planar surface in terms of simplification of geometric correction performed on the image.

The relative positional relationship between the projector 100 and the projection surface SC varies in some cases depending, for example, on how the system 10 is used. The relative positional relationship between the projector 100 and the projection surface SC includes not only the relative positional relationship of the projector 100 with respect to the projection surface SC but also the relative posture relationship of the projector 100 with respect to the projection surface SC. The relative positional relationship of the projector 100 with respect to the projection surface SC changes in accordance with the position or positions where one or both of the projection surface SC and the projector 100 is installed. The relative posture relationship of the projector 100 with respect to the projection surface SC changes in accordance with the posture or postures of one or both of the installed projection surface SC and the projector 100. The position and the posture of the installed projector 100 change, for example, in accordance with conditions such as the position and inclination of an installation surface at which the projector 100 is installed, adjustment made by an adjustment mechanism provided in the projector 100, and adjustment made by an adjustment mechanism provided at a table at which the projector 100 is installed.

Depending on the relative positional relationship between the projector 100 and the projection surface SC, the image projected onto the projection surface SC may be distorted. The projector 100 therefore corrects the distortion of the image on the projection surface SC by using geometric correction such as trapezoidal correction. The geometric correction is, for example, so performed that the image projection region of the projection surface SC has a rectangular shape.

In the present embodiment, a screen coordinate system ES, which is a coordinate system for showing the coordinates of the positions of the pixels on the projection surface SC, and the panel coordinate system EP, which is a coordinate system for showing the coordinates of the positions of the pixels on the panel PL, are used in the description of the correction or the like performed by the projector 100. For example, the screen coordinate system ES is a three-axis orthogonal coordinate system having an Xs-axis, a Ys-axis, and a Zs-axis orthogonal to each other, and the panel coordinate system EP is a three-axis orthogonal coordinate system having an Xp-axis, a Yp-axis, and a Zp-axis orthogonal to each other. It is assumed in the present embodiment that the Zs-axis is parallel to the direction of a normal to the projection surface SC. It is further assumed in the present embodiment that the Zp-axis is parallel to the direction of a normal to the surface of one panel PL representative of the three panels PL. As the panels PL alone, the position on each of the panels PL is expressed by using the Xp-axis and the Yp-axis of the panel coordinate system SP. For example, at corresponding positions in the three panels PL, the coordinates expressed by the Xp-axis and the Yp-axis are the same coordinates in the three panels PL. The screen coordinate system ES is an example of “a first coordinate system” and “a coordinate system of the screen”, and the panel coordinate system EP is an example of a “second coordinate system” and a “coordinate system of the panels”. The Xs-axis, the Ys-axis, and the Zs-axis each have an arrow attached thereto, and the direction indicated by the arrow is defined as a positive direction. For example, the direction indicated by the arrow of the Xs-axis is referred to as a +Xs direction. Similarly, the Xp-axis, the Yp-axis, and the Zp-axis each have an arrow attached thereto, and the direction indicated by the arrow is defined as a positive direction. For example, the direction indicated by the arrow of the Xp-axis is referred to as a +Xp direction.

A quadrangle QU10s on the projection surface SC shown in FIG. 1 corresponds to, for example, the rectangle RE10p, which defines the drawing region DAR1 of the panel PL, and defines the largest drawing region of the projection surface SC. Note that four vertices P10s, P11s, P12s, and P13s of the quadrangle QU10s on the projection surface SC correspond in one-to-one relationship to four vertices P10p, P11p, P12p, and P13p of the rectangle RE10p on the panel PL, that is, in the panel coordinate system CP. That is, the rectangle RE10p in the panel coordinate system EP corresponds to the quadrangle QU10s in the screen coordinate system ES. In other words, the quadrangle QU10s is a quadrangle in which the rectangle RE10p in the panel coordinate system CP is converted into the screen coordinate system ES. The quadrangle QU10s is an example of “a second quadrangle”, and the four vertices P10s, P11s, P12s, and P13s are an example of “four vertices of the second quadrangle”. The four vertices P10p, P11p, P12p, and P13p are four vertices of the rectangle RE10p, which defines the drawing region DAR1 in the panel coordinate system CP. In the following description, the drawing region of the projection surface SC is referred to as a projection region in some cases.

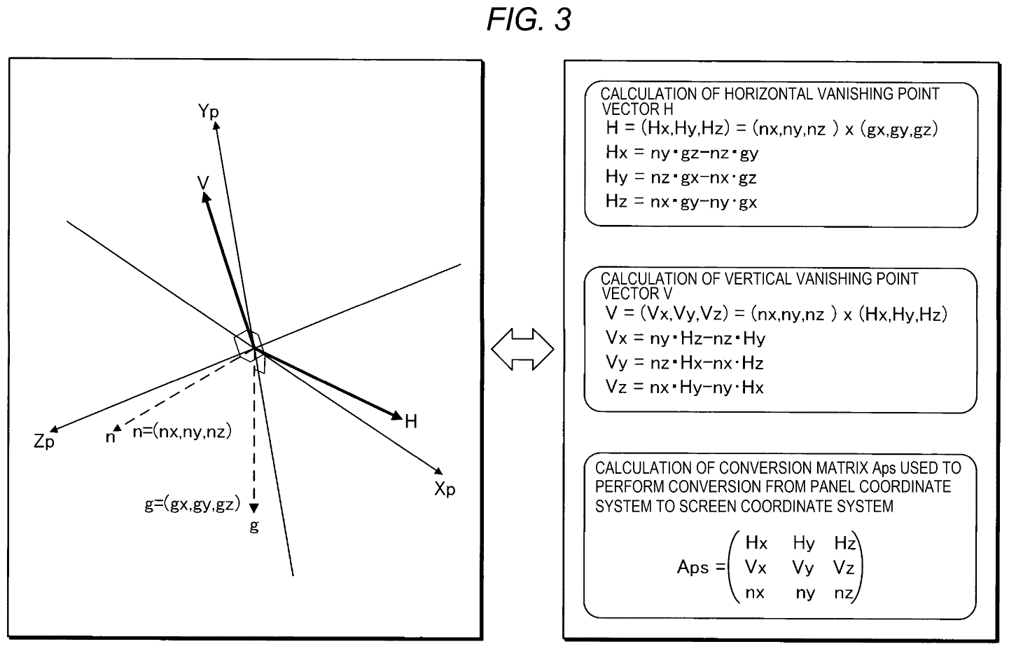

The projection region where an image is projected, that is, an image projection region of the projection surface SC is determined so as to fall within the quadrangle QU10s. The expression “falling within the quadrangle QU10s” means that at least one vertex of a converted rectangle or quadrangle from the panel coordinate system EP to the screen coordinate system ES and defines the projection region is in contact with the contour of the quadrangle QU10s, and the rectangle or the quadrangle has a resolution or an area that does not cause the rectangle or the quadrangle to protrude from the contour of the quadrangle QU10s. A method for determining the projection region will be briefly described with reference to FIG. 1, and will be described in detail later with reference to FIG. 3 and subsequent figures.

For example, the projector 100 identifies the coordinates of the four vertices P10s, P11s, P12s, and P13s in the screen coordinate system ES. The projector 100 then identifies a first intersection coordinates that are the coordinates of a first intersection PI1s in the screen coordinate system ES, at which the two diagonals of the quadrangle QU10s having the four vertices P10s, P11s, P12s, and P13s intersect with each other. The first intersection PI1s is an example of “a point at which two diagonals of the second quadrangle intersect with each other”. In the following description, the coordinates of the first intersection PI1s in the screen coordinate system ES, that is, the first intersection coordinates are referred to as the coordinates of the first intersection PI1s in some cases.

The projector 100 further identifies as a first rectangle RE1s the largest rectangle that falls within the quadrangle QU10s, has a center at the coordinates of the first intersection PI1s, and has a first aspect ratio. At least one of the four vertices of the first rectangle RE1s, which falls within the quadrangle QU10s, is in contact therewith. The first aspect ratio is, for example, equal to the aspect ratio based on the resolution of the panel PL. The aspect ratio based on the resolution of the panel PL is, for example, the aspect ratio of the rectangle RE10p, which defines the drawing region DAR1 of the panel PL. The first aspect ratio corresponds, for example, to an aspect ratio of a typical projector, such as “16:9”, “16:10”, or “4:3”. The first aspect ratio may, however, be an aspect ratio other than the aspect ratios described above by way of example. The projector 100 determines the image projection region of the projection surface SC based on the first rectangle RE1s having the first aspect ratio. Note that the first aspect ratio may be any aspect ratio set by a user within the range of the maximum resolution of the panel PL.

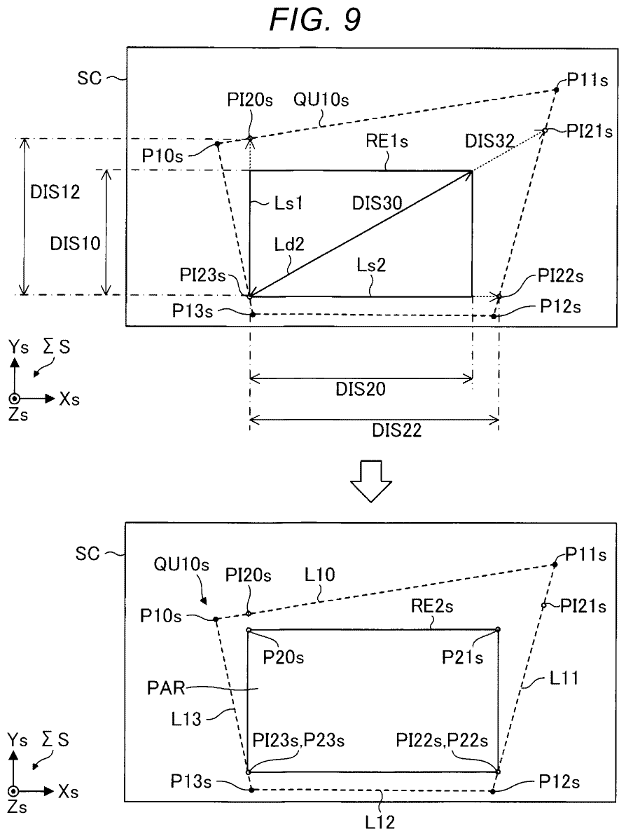

For example, the projector 100 may determine the region defined by the first rectangle RE1s as the image projection region of the projection surface SC. The projector 100 may instead determine the region defined by a rectangle identified based on the first rectangle RE1s as the image projection region of the projection surface SC. The rectangle identified based on the first rectangle RE1s is, for example, a second rectangle RE2s shown in FIG. 9, which will be described later. At least two of the four vertices of the second rectangle RE2s, which falls within the quadrangle QU10s, are in contact therewith. Determining the projection region as described above allows effective use of the drawing region DAR1 of the panel PL provided in the projector 100.

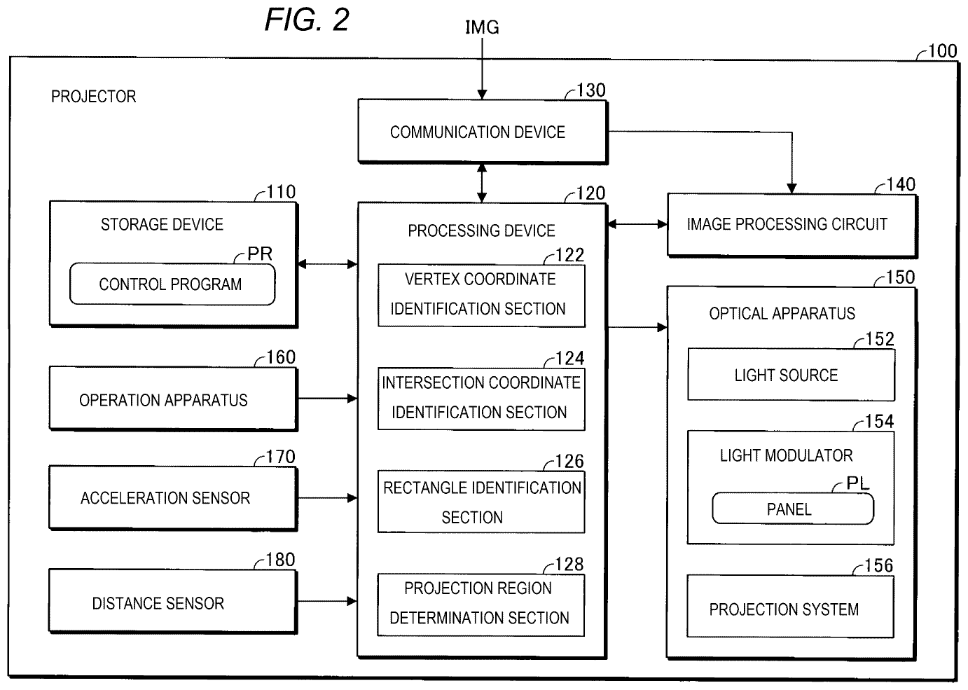

The configuration of the projector 100 will next be described with reference to FIG. 2.

FIG. 2 is a block diagram showing the configuration of the projector 100.

The projector 100 includes a storage device 110, a processing device 120, a communication device 130, an image processing circuit 140, an optical apparatus 150, an operation apparatus 160, an acceleration sensor 170, and a distance sensor 180. For example, the storage device 110, the processing device 120, the communication device 130, the image processing circuit 140, and the acceleration sensor 170 are disposed inside an enclosure, which is not shown, of the projector 100 and are communicatively connected to each other.

The storage device 110 is a storage device that stores various types of information such as a control program PR used to control the projector 100. The storage device 110 includes, for example, a hard disk drive or a semiconductor memory. Note that a portion or the entirety of the storage device 110 may be incorporated in the processing device 120. Instead, a portion or the entirety of the storage device 110 may be provided in a storage device, a server, or the like external to the projector 100. Note that the storage device 110, which stores the control program PR, corresponds to a computer-readable recording medium.

The processing device 120 is a processing device having the function of controlling each portion of the projector 100 and the function of processing various data. The processing device 120 includes, for example, one or more processors, such as a CPU (central processing unit). Note that some or all of the functions of the processing device 120 may be realized by hardware such as a digital signal processor (DSP), an application specific c integrated circuit (ASIC), a programmable logic device (PLD), and a field programmable gate array (FPGA). The processing device 120 may be integrated with the image processing circuit 140. When the first aspect ratio is an aspect ratio randomly set by the user, the processing device 120 may accept the operation of setting the first aspect ratio from the user via, for example, the operation apparatus 160, which will be described later. The operation of setting the first aspect ratio is the operation of selecting one of multiple candidates for the aspect ratio such as “16:9”, “16:10”, or “4:3”.

The processing device 120 functions, for example, as a vertex coordinate identification section 122, an intersection coordinate identification section 124, a rectangle identification section 126, and a projection region determination section 128 by executing the control program PR stored in the storage device 110. The processing device 120 therefore includes the vertex coordinate identification section 122, the intersection coordinate identification section 124, the rectangle identification section 126, and the projection region determination section 128. For example, the image projection region of the projection surface SC is determined by the vertex coordinate identification section 122, the intersection coordinate identification section 124, the rectangle identification section 126, and the projection region determination section 128. When the first aspect ratio is randomly set by the user, the processing device 120 may cause the optical apparatus 150, which will be described later, to project a graphical user interface that accepts the user's operation of setting the first aspect ratio. The processing device 120 is an example of “a processing circuit”. The operation of each of the vertex coordinate identification section 122, the intersection coordinate identification section 124, the rectangle identification section 126, and the projection region determination section 128 will be described with reference to FIG. 3 and subsequent figures, which will be described later.

The communication device 130 is a communication device that can communicate with various instruments, and acquires image data IMG from an instrument that is not shown. For example, the communication device 130 may be a wired communication device such as a wired local area network (LAN), a wireless communication device such as a wireless LAN and Bluetooth, or may have both functions of a wired communication device and a wireless communication device. “Bluetooth” is a registered trademark. Examples of the wireless LAN may include a low power wide area (LPWA) and Wi-Fi. “Wi-Fi” is a registered trademark. In addition to the wired LAN, examples of the wired communication device may include a universal serial bus (USB) and a high definition multimedia interface (HDMI). “HDMI” is a registered trademark.

The image processing circuit 140 is a circuit that performs necessary processing on the image data IMG acquired by the communication device 130 and inputs the processed image data IMG to the optical apparatus 150. For example, the image processing circuit 140 includes a frame memory that is not shown and loads the image data IMG into the frame memory. The image processing circuit 140 then performs various processing such as resolution conversion, resizing, and distortion correction as appropriate on the image data IMG loaded into the frame memory, and inputs the processed image data IMG to the optical apparatus 150. Note that the image processing circuit 140 may perform processing such as on-screen display (OSD) as necessary, in which image information used, for example, to display a menu or provide operation guidance is generated and combined with the image data IMG.

The optical apparatus 150 is an apparatus that displays an image by projecting image light onto the projection surface SC. In the present embodiment, appropriately determining the image projection region of the projection surface SC suppresses distortion produced in a projection image that is the image appearing on the projection surface SC when the optical apparatus 150 projects the image light. The optical apparatus 150 includes a light source 152, a light modulator 154, and a projection system 156.

The light source 152 includes a light source, for example, a halogen lamp, a xenon lamp, an ultrahigh-pressure mercury lamp, LEDs (light emitting diodes), or laser light sources, and outputs red light, green light, and blue light. The light modulator 154 includes three light modulators provided in correspondence with red, green, and blue. The light modulators include, for example, the panels PL, and generate image light of the corresponding colors by modulating light of the colors. For example, when the panels PL are transmissive liquid crystal panels, the light transmittance of the pixels arranged in the drawing region DAR1 of each of the panels PL are set based on the image data IMG processed by the image processing circuit 140. The light output from the light source 152 is thus modulated when passing through the drawing region DAR1 of each of the panels PL. The multiple types of color image light generated by the light modulator 154 are combined with one another by a light combining system into full-color image light. The projection system 156 is an optical system including a projection lens and other elements that cause the full-color image light from the light modulator 154 into focus and projects the resultant image onto the projection surface SC.

The operation apparatus 160 is an apparatus that accepts the user's operation. For example, the operation apparatus 160 includes an operation panel that is not shown. The operation panel is provided on an exterior enclosure of the projector 100, and outputs a signal based on the user's operation. Note that a wireless or wired remote control that transmits the signal based on the user's operation may be used as the operation apparatus 160. In this case, the projector 100 includes a remote control light receiver as a portion of the operation apparatus 160. For example, the remote control light receiver receives an infrared signal from the remote control, which is not shown, decodes the infrared signal, and outputs a signal based on the operation performed on the remote control. Note that the operation apparatus 160 is provided as necessary and may be omitted.

The acceleration sensor 170 is a sensor that detects acceleration in each of the three axes orthogonal to each other, and detects acceleration acting on the projector 100. The acceleration sensor 170 is built in the projector 100 and fixed to a predetermined location in the enclosure of the projector 100. The predetermined location to which the acceleration sensor 170 is fixed is, for example, a circuit substrate (not shown) on which the processing device 120 is mounted. Note that the predetermined location to which the acceleration sensor 170 is fixed is not limited to the circuit substrate on which the processing device 120 is mounted. The acceleration sensor 170 outputs, for example, a signal according to acceleration in the direction along each of the Xp-axis, the −Yp axis, and the −Zp axis of the panel coordinate system ΣP. The acceleration sensor 170 is fixed to the predetermined location in the enclosure of the projector 100, so that the position of the acceleration sensor 170 in the enclosure is identified. A relative positional relationship between the one panel PL, which is representative of the three panels PL, and the acceleration sensor 170 is thus identified in advance. As a result, the acceleration sensor 170 is associated with the panel coordinate system CP. For example, a gravity vector g based on the output from the acceleration sensor 170 is expressed by using the panel coordinate system CP, as shown in FIG. 3, which will be described later.

The distance sensor 180 is a time-of-flight (TOF) distance sensor, and measures the distance to the projection surface SC. The distance sensor 180 is fixed to a predetermined location in the projector 100, so that the position of the distance sensor 180 in the projector 100 is identified. A relative positional relationship between the one panel PL, which is representative of the three panels PL, and the distance sensor 180 is thus identified in advance. As a result, the distance sensor 180 is associated with the panel coordinate system CP. For example, the projector 100, in more detail, the vertex coordinate identification section 122 can calculate a normal vector n to the projection surface SC and shown in FIG. 3, which will be described later, based on a depth map of the projection surface SC based on the output from the distance sensor 180. The normal vector n with respect to the projection surface SC is expressed, for example, by the panel coordinate system CP. Note that a method for calculating the normal vector n with respect to the projection surface SC is not limited to the method using the time-of-flight distance sensor 180. For example, the normal vector n with respect to the projection surface SC may be calculated based on the result of camera-based triangulation.

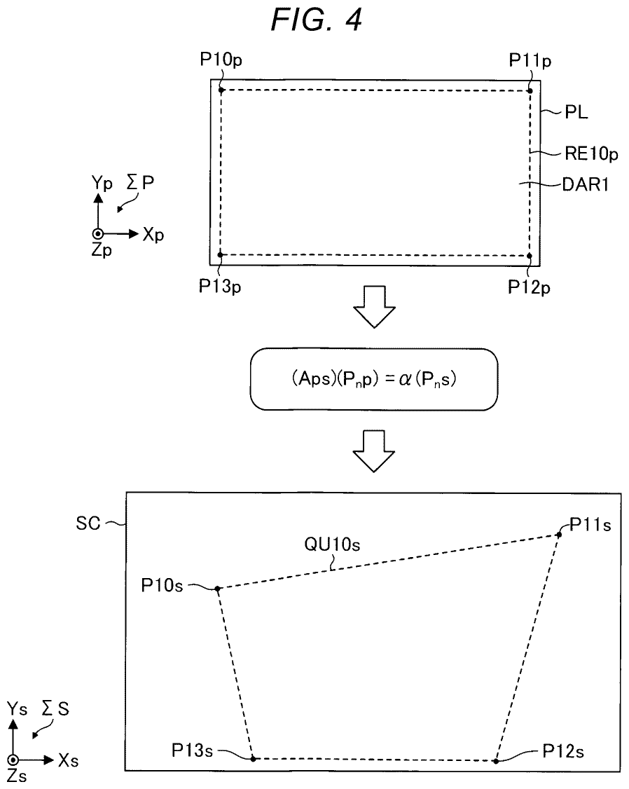

The operation of the vertex coordinate identification section 122 will next be described with reference to FIGS. 3 and 4.

FIG. 3 is a descriptive diagram for illustrating an example of a method for calculating a conversion matrix Aps used to perform the conversion from the panel coordinate system EP into the screen coordinate system ΣS.

It is assumed in the present embodiment that the Xs-axis of the screen coordinate system ES is parallel to the horizontal plane. It is further assumed in the present embodiment that the Zs-axis of the screen coordinate system ES is parallel to the direction of a normal to the projection surface SC, as described above. The present embodiment can therefore use a property in which the outer product of the gravity vector g, which indicates the direction of gravity, and the normal vector n, which indicates the direction of the normal to the projection surface SC, is parallel to the horizontal plane.

For example, the vertex coordinate identification section 122 calculates the gravity vector g based on the output from the acceleration sensor 170 associated with the panel coordinate system CP. The vertex coordinate identification section 122 further calculates the normal vector n based on the depth map of the projection surface SC based on the output from the distance sensor 180 associated with the panel coordinate system CP. The vertex coordinate identification section 122 then calculates the conversion matrix Aps, which converts the coordinate system from the panel coordinate system EP to the screen coordinate system ES, by using the gravity vector g and the normal vector n. The positional relationship between the acceleration sensor 170 and the panels PL is calibrated, for example, when the projector 100 is manufactured. The acceleration sensor 170 is thus associated with the panel coordinate system CP.

Specifically, for example, the vertex coordinate identification section 122 calculates the outer product of the normal vector n and the gravity vector g as a horizontal vanishing point vector H indicating the direction of a horizontal vanishing point in the screen coordinate system ES. Assuming that the horizontal vanishing point vector H is expressed by (Hx, Hy, Hz), the normal vector n is expressed by (nx, ny, nz), and the gravity vector g is expressed by (gx, gy, gz), the horizontal vanishing point vector H is expressed by Expressions (1) to (4).

$$H = ( Hx , Hy , Hz ) = ( nx , ny , nz ) \times ( gx , gy , gz ) \qquad ( 1 )$$

$$Hx = ny \cdot gz - nz \cdot gy \qquad ( 2 )$$

$$Hy = nz \cdot gx - nx \cdot gz \qquad ( 3 )$$

$$Hz = nx \cdot gy - ny \cdot gx \qquad ( 4 )$$

The vertex coordinate identification section 122 further calculates the outer product of the normal vector n and the horizontal vanishing point vector H as a vertical vanishing point vector V indicating the direction of a vertical vanishing point in the screen coordinate system ES. Assuming that the vertical vanishing point vector Vis expressed by (Vx, Vy, Vz), the vertical vanishing point vector V is expressed by Expressions (5) to (8).

$$V = ( Vx , Vy , Vz ) = ( nx , ny , nz ) \times ( Hx , Hy , Hz ) \qquad ( 5 )$$

$$Vx = ny \cdot Hz - nz \cdot Hy \qquad ( 6 )$$

$$Vy = nz \cdot Hx - nx \cdot Hz \qquad ( 7 )$$

$$Vz = nx \cdot Hy - ny \cdot Hx \qquad ( 8 )$$

The vertex coordinate identification section 122 then identifies the conversion matrix Aps based on the horizontal vanishing point vector H, the vertical vanishing point vector V, and the normal vector n. For example, the conversion matrix Aps is expressed by Expression (9).

$$Aps = ( \begin{matrix}Hx & Hy & Hz \\ Vx & Vy & Vz \\ nx & ny & nz\end{matrix} ) \qquad ( 9 )$$

The method for calculating the conversion matrix Aps is not limited to the example described above, and a known method can be employed. For example, the horizontal vanishing point vector H, which constitutes the components of the conversion matrix Aps, may be the outer product of the normal vector n and a unit vector e having a component only in the −Ys direction in place of the outer product of the normal vector n and the gravity vector g. The unit vector e is (0, −1, 0).

The vertex coordinate identification section 122 identifies the coordinates, in the screen coordinate system ES, of one point on the projection surface SC that corresponds to the one point on each of the panels PL by using the conversion matrix Aps, as shown, for example, in FIG. 4.

FIG. 4 is a descriptive diagram for illustrating a method for identifying the coordinates, in the screen coordinate system IS, of the four vertices P10s, P11s, P12s, and P13s on the projection surface SC, which correspond in one-to-one relationship to the four vertices P10p, P11p, P12p, and P13p on the panel PL.

The four vertices P10p, P11p, P12p, and P13p on the panel PL are the vertices of the rectangle RE10p, which defines the drawing region DAR1 of the panel PL. The coordinates of the four vertices P10s, P11s, P12s, and P13s on the projection surface SC, which correspond in one-to-one relationship to the four vertices P10p, P11p, P12p, and P13p, in the screen coordinate system ES are calculated by using the conversion matrix Aps. For example, the coordinates of one vertex Pₙs of the four vertices P10s, P11s, P12s, and P13s in the screen coordinate system ES are calculated based on the product of the conversion matrix Aps and a vertex Pₙp, as indicated by Expression (10).

$$( Aps ) ( {P}_{n} p ) = α ( {P}_{n} s ) \qquad ( 10 )$$

Note that the vertex Pop in Expression (10) is a vertex corresponding to the vertex Pₙs out of the four vertices P10p, P11p, P12p, and P13p. The value x in Expression (10) is a value according to the distance between the panel PL and the projection surface SC. The value x may or may not be identified. It is assumed in the present embodiment that the value x is not particularly identified.

As described above, the coordinates of the four vertices P10s, P11s, P12s, and P13s of the projection surface SC, which correspond in one-to-one relationship to the four vertices P10p, P11p, P12p, and P13p on the panel PL, in the screen coordinate system ES are identified based on the conversion matrix Aps. The conversion matrix Aps is an example of “a correspondence that associates the second coordinate system and the first coordinate system with each other”.

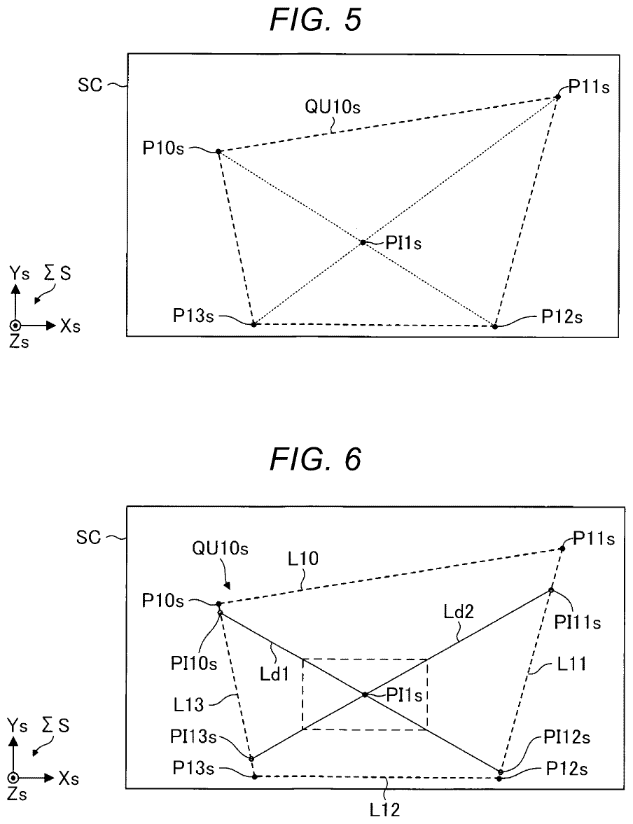

The region on the projection surface SC that is defined by the quadrangle QU10s having the four vertices P10s, P11s, P12s, and P13s corresponds, for example, to the drawing region DAR1 of the panel PL, and is the largest drawing region of the projection surface SC. FIG. 4 illustrates a case where the region on the projection surface SC that corresponds to the drawing region DAR1 of the panel PL is distorted. In the present embodiment, the image drawing region of the projection surface SC, that is, the image projection region of the projection surface SC is corrected so as to be rectangular, so that distortion produced in the image on the projection surface SC is suppressed. For example, in the present embodiment, the projection region of the projection surface SC is determined based on the first rectangle RE1s having the first aspect ratio and having a center at the first intersection PI1s, at which the two diagonals of the quadrangle QU10s intersect with each other, as shown in FIGS. 5 to 9.

The operation of the intersection coordinate identification section 124, which identifies the coordinates of the first intersection PI1s, will next be described with reference to FIG. 5.

FIG. 5 is a descriptive diagram for illustrating the operation of the intersection coordinate identification section 124.

The intersection coordinate identification section 124 identifies first intersection coordinates that are the coordinates of the first intersection PI1s in the screen coordinate system ES, at which the two diagonals (first and second diagonals) of the quadrangle QU10s having the four vertices P10s, P11s, P12s, and P13s intersect with each other. For example, the intersection coordinate identification section 124 calculates the expression of the straight line passing through the vertices P10s and P12s based on the coordinates of the vertices P10s and P12s in the screen coordinate system ES. At least a portion of the straight line passing through the vertices P10s and P12s constitutes the first diagonal of the quadrangle QU10s. That is, the intersection coordinate identification section 124 calculates the expression representing the first diagonal of the quadrangle QU10s based on the coordinates of the vertices P10s and P12s. The intersection coordinate identification section 124 further calculates the expression of the straight line passing through the vertices P11s and P13s based on the coordinates of the vertices P11s and P13s in the screen coordinate system ES. At least a portion of the straight line passing through the vertices P11s and P13s constitutes the second diagonal of the quadrangle QU10s. That is, the intersection coordinate identification section 124 calculates the expression representing the second diagonal of the quadrangle QU10s based on the coordinates of the vertices P11s and P13s. The intersection coordinate identification section 124 then calculates as the first intersection coordinates the coordinates of the intersection (first intersection PI1s) of the straight line passing through the vertices P10s and P12s and the straight line passing through the vertices P11s and P13s based on the expression of the straight line passing through the vertices P10s and P12s and the expression of the straight line passing through the vertices P11s and P13s. The intersection coordinate identification section 124 therefore identifies the first intersection coordinates based on the coordinates of the vertices P10s, P11s, P12s, and P13s in the screen coordinate system ES.

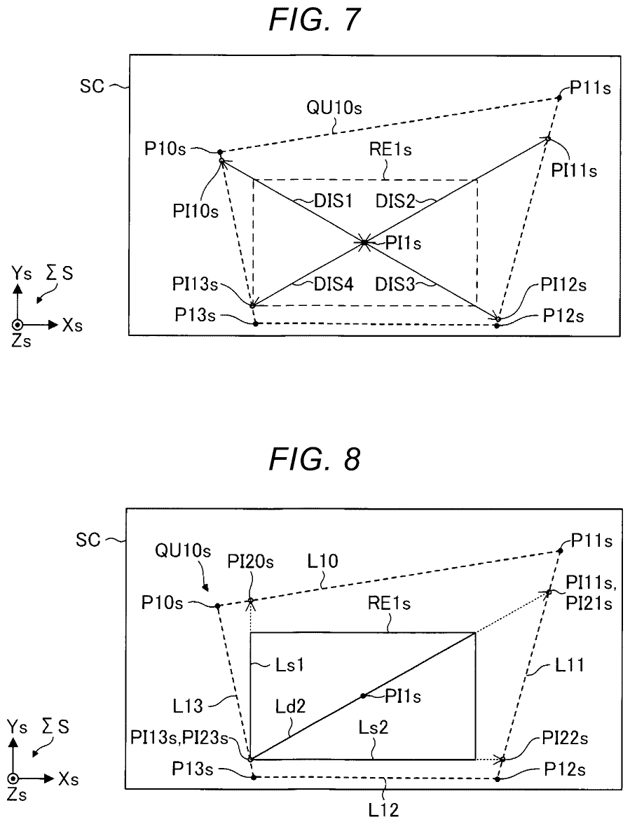

A method for identifying the first rectangle RE1s having the first aspect ratio and having a center at the first intersection PI1s will next be described with reference to FIGS. 6 and 7.

FIG. 6 is a descriptive diagram for illustrating an example of the method for identifying the first rectangle RE1s having the first aspect ratio and having a center at the first intersection PI1s. The first rectangle RE1s is the largest rectangle that falls within the quadrangle QU10s out of rectangles having a center at the first intersection PI1s and having the first aspect ratio, as described with reference to FIG. 1. The maximum rectangle is a rectangle having the maximum resolution or area.

For example, the rectangle identification section 126 calculates the expression of a straight line Ld1 passing through the start point and the end point of one of the two diagonals (third and fourth diagonals) of a rectangle having a center at the first intersection PI1s and having the first aspect ratio, and the expression of a straight line Ld2 passing through the start point and the end point of the other of the two diagonals. Note that the rectangle having a center at the first intersection PI1s and having the first aspect ratio is, for example, a rectangle having two sides parallel to the Xs-axis and two sides parallel to the Ys-axis. In FIG. 6, an example of the rectangle having a center at the first intersection PI1s and having the first aspect ratio is indicated by the broken line so that the straight lines Ld1 and Ld2 readily come to mind.

The expressions representing the two straight lines Ld1 and Ld2 corresponding to the two diagonals of the rectangle having a center at the first intersection PI1s and having the first aspect ratio are calculated based on the first intersection coordinates, which are the coordinates of the first intersection PI1s, and the first aspect ratio.

Furthermore, for example, the rectangle identification section 126 calculates the expression of a straight line L10 passing through the vertices P10s and P11s based on the coordinates of the vertices P10s and P11s, and calculates the expression of a straight line L11 passing through the vertices P11s and P12s based on the coordinates of the vertices P11s and P12s. The rectangle identification section 126 further calculates the expression of a straight line L12 passing through the vertices P12s and P13s based on the coordinates of the vertices P12s and P13s, and calculates the expression of a straight line L13 passing through the vertices P10s and P13s based on the coordinates of the vertices P10s and P13s.

The rectangle identification section 126 then calculates the intersections of each of the straight lines L10, L11, L12, and L13 and each of the straight lines Ld1 and Ld2. In FIG. 6, out of the intersections of each of the straight lines L10, L11, L12, and L13 and each of the straight lines Ld1 and Ld2, the intersections located outside the quadrangle QU10s are omitted for clarity. That is, FIG. 6 shows, out of the intersections of each of the straight lines L10, L11, L12, and L13 and each of the straight lines Ld1 and Ld2, only the intersections located on the sides of the quadrangle QU10s.

For example, FIG. 6 shows, out of the intersections of the straight line L10, L11, L12, or L13 and the straight line Ld1, an intersection PI10s of the straight line Ld1 and the straight line that couples the vertex P10s to the vertex P13s and an intersection PI12s of the straight line Ld1 and the straight line that couples the vertex P11s to the vertex P12s. FIG. 6 further shows, out of the intersections of the straight line L10, L11, L12, or L13 and the straight line Ld2, an intersection PI13s of the straight line Ld2 and the straight line that couples the vertex P10s to the vertex P13s and an intersection PI11s of the straight line Ld2 and the straight line that couples the vertex P11s to the vertex P12s. That is, FIG. 6 does show none of the intersection of the straight line L10 and the straight line Ld1, the intersection of the straight line L12 and the straight line Ld1, the intersection of the straight line L10 and the straight line Ld2, and the intersection of the straight line L12 and the straight line Ld2.

Out of the intersections of each of the straight lines L10, L11, L12, and L13 and each of the straight lines Ld1 and Ld2, the intersection closest to the first intersection PI1s is one of the four vertices of the first rectangle RE1s, as shown in FIG. 7.

FIG. 7 is a descriptive diagram for illustrating the remaining portion of the method for identifying the first rectangle RE1s.

Out of the intersections of each of the straight lines L10, L11, L12, and L13 and each of the straight lines Ld1 and Ld2, the rectangle identification section 126 identifies the intersection closest to the first intersection PI1s as one of the four vertices of the first rectangle RE1s. That is, the rectangle identification section 126 identifies the intersection closest to the first intersection PI1s out of the intersections PI10s and PI12s of a side of the quadrangle QU10s and the straight line Ld1, and the intersections PI11s and PI13s of a side of the quadrangle QU10s and the straight line Ld2 as one of the four vertices of the first rectangle RE1s. In the example shown in FIG. 7, out of a distance DIS1 between the first intersection PI1s and the intersection PI10s, a distance DIS2 between the first intersection PI1s and the intersection PI1s, a distance DIS3 between the first intersection PI1s and the intersection PI12s, and a distance DIS4 between the first intersection PI1s and the intersection PI13s, the distance DIS4 is the shortest. The rectangle identification section 126 therefore identifies the intersection PI13s out of the intersections PI10s, PI11s, PI12s, and PI13s as one of the four vertices of the first rectangle RE1s.

The rectangle identification section 126 then identifies as the first rectangle RE1s a rectangle having a center at the first intersection PI1s, having the first aspect ratio, having four vertices one of which is the intersection PI13s, and having two sides parallel to the Xs-axis and two sides parallel to the Ys-axis. For example, the rectangle identification section 126 identifies as the first rectangle RE1s a rectangle having four vertices each of which is located on the straight line Ld1 or Ld2 and one of which is the intersection PI13s. The largest rectangle that falls within the quadrangle QU10s, has a center at the first intersection coordinates that are the coordinates of the first intersection PI1s, and has the first aspect ratio is thus identified as the first rectangle RE1s.

Note that out of the intersections of each of the straight lines L10, L11, L12, and L13 and each of the straight lines Ld1 and Ld2, the intersections located outside the quadrangle QU10s are not candidates for the intersection closest to the first intersection PI1s. The rectangle identification section 126 therefore does not need to calculate the intersections located outside the quadrangle QU10s out of the intersections of each of the straight lines L10, L11, L12, and L13 and each of the straight lines Ld1 and Ld2.

The region defined by the first rectangle RE1s may be determined as the image projection region of the projection surface SC, but it is assumed in the present embodiment that the region defined by the second rectangle RE2s shown in FIG. 9, which will be described later, is determined as the image projection region of the projection surface SC. The second rectangle is, for example, a rectangle that falls within the quadrangle QU10s, is larger than the first rectangle RE1s, and has the first aspect ratio, and is identified based on the first rectangle RE1s.

A method for identifying the second rectangle RE2s will next be described with reference to FIGS. 8 and 9.

FIG. 8 is a descriptive diagram for illustrating an example of the method for identifying the second rectangle RE2s.

The rectangle identification section 126 identifies a point where the first rectangle RE1s and the quadrangle QU10s are in contact with each other as a reference point. That is, out of the intersections of each of the straight lines L10, L11, L12, and L13 and each of the straight lines Ld1 and Ld2, the rectangle identification section 126 identifies the intersection closest to the first intersection PI1s as the reference point. In the example shown in FIG. 8, the rectangle identification section 126 identifies the intersection PI13s, where the first rectangle RE1s and the quadrangle QU10s are in contact with each other, as the reference point.

The rectangle identification section 126 calculates the intersections where the straight lines passing through the reference point and the three vertices other than the reference point out of the four vertices of the first rectangle RE1s intersect with sides of the quadrangle QU10s. That is, the rectangle identification section 126 calculates the intersections where the straight lines passing through the intersection PI13s and the three vertices other than the intersection PI13s out of the four vertices of the first rectangle RE1s intersect with sides of the quadrangle QU10s.

Specifically, for example, the rectangle identification section 126 calculates an intersection PI20s, where a straight line Ls1, which is an extension of the side passing through the intersection PI13s out of the two sides of the first rectangle RE1s that are parallel to the Ys-axis, intersects with a side of the quadrangle QU10s. The value of the intersection PI20s along the Ys-axis is calculated, for example, by substituting the value of the intersection PI13s along the Xs-axis into the expression of the straight line L10. Note that the point identified by substituting the value of the intersection PI13s along the Xs-axis into the expression of each of the straight lines L11 and L12 is not located on any side of the quadrangle QU10s, and is therefore not the intersection of the straight line Ls1 and a side of the quadrangle QU10s. For example, the intersection of the straight line Ls1 and a side of the quadrangle QU10s is one of the intersections of the straight lines L10, L11, and L12 and the straight line Ls1, that is, an intersection so located that the value thereof along the Ys-axis and the value of the intersection PI13s along the Ys-axis sandwich the value of the first intersection PI1s along the Ys-axis.

For example, the rectangle identification section 126 further calculates an intersection PI22s, where a straight line Ls2, which is an extension of the side passing through the intersection PI13s out of the two sides of the first rectangle RE1s that are parallel to the Xs-axis, intersects with a side of the quadrangle QU10s. The value of the intersection PI22s along the Xs-axis is calculated, for example, by substituting the value of the intersection PI13s along the Ys-axis into the expression of the straight line L11. Note that the point identified by substituting the value of the intersection PI13s along the Ys-axis into the expression of each of the straight lines L10 and L12 is not located on any side of the quadrangle QU10s, and is therefore not the intersection of the straight line Ls2 and a side of the quadrangle QU10s. For example, the intersection of the straight line Ls2 and a side of the quadrangle QU10s is one of the intersections of the straight lines L10, L11, and L12 and the straight line Ls2, that is, the intersection so located that the value, along the Xs-axis, of the intersection of the straight line Ls2 and a side of the quadrangle QU10s and the value of the intersection PI13s along the Xs-axis sandwich the value of the first intersection PI1s along the Xs-axis

Note in the present embodiment that an intersection PI21s, where the straight line Ld2, which is an extension of the diagonal passing through the intersection PI13s out of the two diagonals of the first rectangle RE1s, intersects with a side of the quadrangle QU10s, is the intersection PI11s described with reference to FIG. 6, and has been already calculated. The point identified based on the expressions of the straight lines L10 and L12 and the expression of the straight line Ld2 is not located on any side of the quadrangle QU10s, and is therefore not the intersection of the straight line Ld2 and a side of the quadrangle QU10s. For example, the intersection of the straight line Ld2 and a side of the quadrangle QU10s is one of the intersections of each of the straight lines L10, L11, and L12 and the straight line Ld2, that is, the intersection so located that the first intersection PI1s is located on the straight line that couples the intersection of the straight line Ld2 and a side of the quadrangle QU10s to the intersection PI13s.

In the following description, the intersection PI13s is referred to as an intersection PI23s in some cases in accordance with the intersections PI20s, PI21s, and PI22s.

One of two vertices of four vertices P20s, P21s, P22s, and P23s of the second rectangle RE2s is the intersection PI23s, which is the reference point, and one of the intersections PI20s, PI21s, and PI22s is identified as the other of the two vertices, as shown in FIG. 9.

FIG. 9 is a descriptive diagram for illustrating the remaining portion of the method for identifying the second rectangle RE2s.

The rectangle identification section 126 identifies, as one of the four vertices P20s, P21s, P22s, and P23s of the second rectangle RE2s, the intersection where the factor by which the first rectangle RE1s is enlarged is minimized out of the intersections PI20s, PI21s, and PI22s.

For example, the rectangle identification section 126 calculates a distance DIS10 between the start point and the end point of a side of the first rectangle RE1s that is parallel to the Ys-axis, a distance DIS20 between the start point and the end point of a side of the first rectangle RE1s that is parallel to the Xs-axis, and a distance DIS30 between the start point and the end point of a diagonal of the first rectangle RE1s. Note that the distance DIS10 corresponds to the length of the side of the first rectangle RE1s that is parallel to the Ys-axis, the distance DIS20 corresponds to the length of the side of the first rectangle RE1s that is parallel to the Xs-axis, and the distance DIS30 corresponds to the length of the diagonal of the first rectangle RE1s. The rectangle identification section 126 further calculates a distance DIS12 between the intersection PI20s and the intersection PI23s, a distance DIS22 between the intersection PI22s and the intersection PI23s, and a distance DIS32 between the intersection PI21s and the intersection PI23s.

The rectangle identification section 126 then calculates, for example, a first ratio that is the ratio of the distance DIS12 to the distance DIS10, a second ratio that is the ratio of the distance DIS22 to the distance DIS20, and a third ratio that is the ratio of the distance DIS32 to the distance DIS30. In the following description, an intersection that is one of elements that determine each of the first ratio, the second ratio, and the third ratio is referred to as an intersection corresponding to the ratio in some cases. For example, the intersection PI22s, which is one of the elements that determine the second ratio, is referred to as the intersection PI22s corresponding to the second ratio in some cases.

The rectangle identification section 126 identifies the intersection corresponding to the smallest of the first ratio, the second ratio, and the third ratio described above out of the intersections PI20s, PI21s, and PI22s as one of the four vertices P20s, P21s, P22s, and P23s of the second rectangle RE2s. In the example shown in FIG. 9, the second ratio is the smallest of the first ratio, the second ratio, and the third ratio. The rectangle identification section 126 therefore identifies the intersection PI22s corresponding to the second ratio out of the intersections PI20s, PI21s, and PI22s as one of the four vertices P20s, P21s, P22s, and P23s of the second rectangle RE2s.

The rectangle identification section 126 then identifies as the second rectangle RE2s a rectangle having four vertices two of which are the intersections PI22s and PI23s and having the first aspect ratio. In the example shown in FIG. 9, the vertex P22s of the second rectangle RE2s is the intersection PI22s, and the vertex P23s of the second rectangle RE2s is the intersection PI23s.

Note, for example, that the coordinates of the vertex P20s of the second rectangle RE2s are identified based on the coordinates of the intersection PI23s, which is the vertex P23s, the distance DIS22 between the intersection PI22s and the intersection PI23s, and the first aspect ratio. Furthermore, for example, the coordinates of the vertex P21s of the second rectangle RE2s are identified based on the coordinates of the vertex P20s and the coordinates of the intersection PI22s, which is the vertex P22s.

As described above, the rectangle identification section 126 identifies as the second rectangle RE2s a rectangle having four vertices one of which is the intersection PI23s identified as the reference point, having the first aspect ratio, and being the largest but not protruding from the quadrangle QU10s. Note that the second rectangle RE2s may not be the largest rectangle but may be any rectangle that has four vertices one of which is the reference point, has the first aspect ratio, and is larger than the first rectangle RE1s but does not protrude from the quadrangle QU10s. That is, the rectangle identification section 126 may identify as the second rectangle RE2s a rectangle that has four vertices one of which is the intersection PI23s identified as the reference point, has the first aspect ratio, and is larger than the first rectangle RE1s but does not protrude from the quadrangle QU10s.

Note that the method for identifying the second rectangle RE2s is not limited to the method described above. For example, the rectangle identification section 126 identifies a first candidate rectangle having four vertices two of which are the intersection PI23s, which is the reference point, and the intersection PI20s and having the first aspect ratio. The rectangle identification section 126 further identifies a second candidate rectangle having four vertices two of which are the intersection PI23s and the intersection PI21 and having the first aspect ratio, and a third candidate rectangle having four vertices two of which are the intersection PI23s and the intersection PI22 and having the first aspect ratio. The rectangle identification section 126 may then identify as the second rectangle RE2s the largest rectangle that does not protrude from the quadrangle QU10s out of the first, second, and third candidate rectangles.

In the present embodiment, the projection region determination section 128 determines the region defined by the second rectangle RE2s as an image projection region PAR of the projection surface SC. The region of each of the panels PL that corresponds to the region defined by the second rectangle RE2s corresponds to the drawing region of the panel PL after the correction.

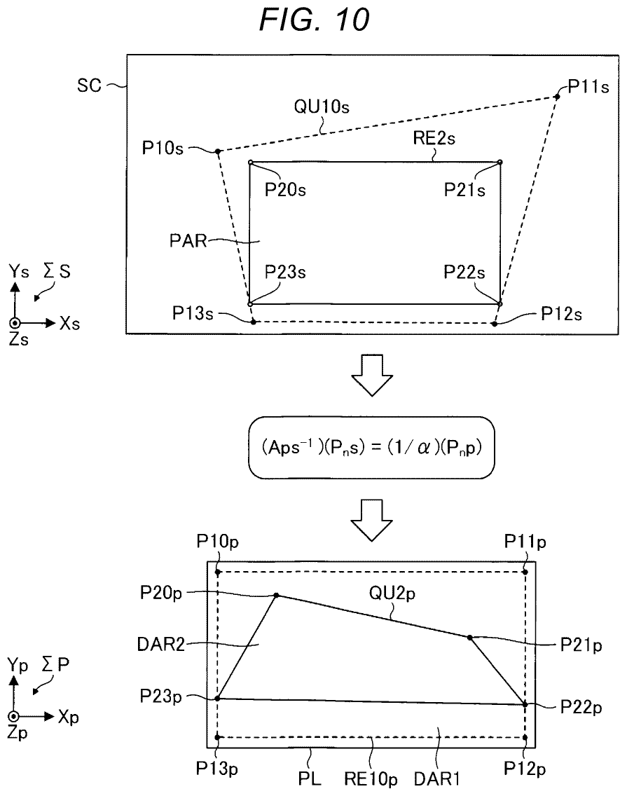

A method for identifying a drawing region DAR2 of each of the panels PL after the correction will next be described with reference to FIG. 10.

FIG. 10 is a descriptive diagram for illustrating the method for identifying the drawing region DAR2 of each of the panels PL after the correction.

Four vertices P20p, P21p, P22p, and P23p of a quadrangle QU2p, which defines the drawing region DAR2 of each of the panels PL after the correction, correspond in one-to-one relationship to the four vertices P20s, P21s, P22s, and P23s of the second rectangle RE2s in the screen coordinate system ES. The coordinates of the four vertices P20p, P21p, P22p, and P23p on the panel PL in the panel coordinate system EP that correspond in one-to-one relationship to the four vertices P20s, P21s, P22s, and P23s are calculated by using an inverse matrix Aps⁻¹ of the conversion matrix Aps. For example, the coordinates of one vertex Pₙp of the four vertices P20p, P21p, P22p, and P23p in the panel coordinate system EP are calculated based on the product of the inverse matrix Aps⁻¹ of the conversion matrix Aps and a vertex Pₙs, as indicated by Expression (11).

$$( {Aps}^{- 1} ) ( {P}_{n} s ) = ( 1 / α ) ( {P}_{n} p ) \qquad ( 11 )$$

Note that the vertex Pas in Expression (11) is a vertex corresponding to the vertex Pop out of the four vertices P20s, P21s, P22s, and P23s. The value σ in Expression (11) is equal to the value σ in Expression (10) described above, and is a value according to the distance between the panel PL and the projection surface SC.

As described above, the coordinates of the four vertices P20p, P21p, P22p, and P23p of the panel PL in the panel coordinate system CP that correspond in one-to-one relationship to the four vertices P20s, P21s, P22s, and P23s on the projection surface SC are identified based on the inverse matrix Aps⁻¹ of the conversion matrix Aps.

The drawing region DAR2 of the panel PL, which is defined by the quadrangle QU2p having four vertices P20p, P21p, P22p, and P23p, corresponds, for example, to the region defined by the second rectangle RE2s on the projection surface SC. For example, the projector 100 corrects an image in the drawing region DAR1 of the panel PL to an image in the drawing region DAR2. The projector 100 then projects the image drawn in the drawing region DAR2 of the panel PL, that is, the corrected image onto the projection surface SC. The region of the projection surface SC that corresponds to the drawing region DAR2 of the panel PL is the region defined by the second rectangle RE2s, as described above. The projection region PAR of the projection surface SC, where the image drawn in the drawing region DAR2 of the panel PL is projected, is therefore rectangular. As a result, in the present embodiment, distortion produced in the image on the projection surface SC can be suppressed.

In the present embodiment, one of the four vertices P20s, P21s, P22s, and P23s of the second rectangle RE2s is one of the four vertices of the first rectangle RE1s. The first rectangle RE1s is a rectangle that has a center at the first intersection PI1s, has the first aspect ratio, and is the largest but does not protrude from the quadrangle QU10s on the projection surface SC, which corresponds to the rectangle RE10p, which defines the largest drawing region DAR1 of the panel PL. In the present embodiment, the drawing region DAR1 of the panel PL provided in the projector 100 can therefore be effectively used.

In the present embodiment, since one of the four vertices P20s, P21s, P22s, and P23s of the second rectangle RE2s is one of the four vertices of the first rectangle RE1s, a situation in which the center of the second rectangle RE2s is far from the center of the first rectangle RE1s can be avoided. The first intersection PI1s, which is the center of the first rectangle RE1s, is the intersection of the two diagonals of the quadrangle QU10s on the projection surface SC, which corresponds to the rectangle RE10p, which defines the drawing region DAR1, as described above. In this case, the projection region PAR defined by the second rectangle RE2s appears near the center in the direction facing the projector 100 installed by the user, so that a situation in which the user loses his/her intuition about an image projected onto the projection surface SC when the user views the image. The situation in which the user loses his/her intuition about an image projected onto the projection surface SC when the user views the image means, for example, that the user feels uncomfortable when the user views the image projected onto the projection surface SC.

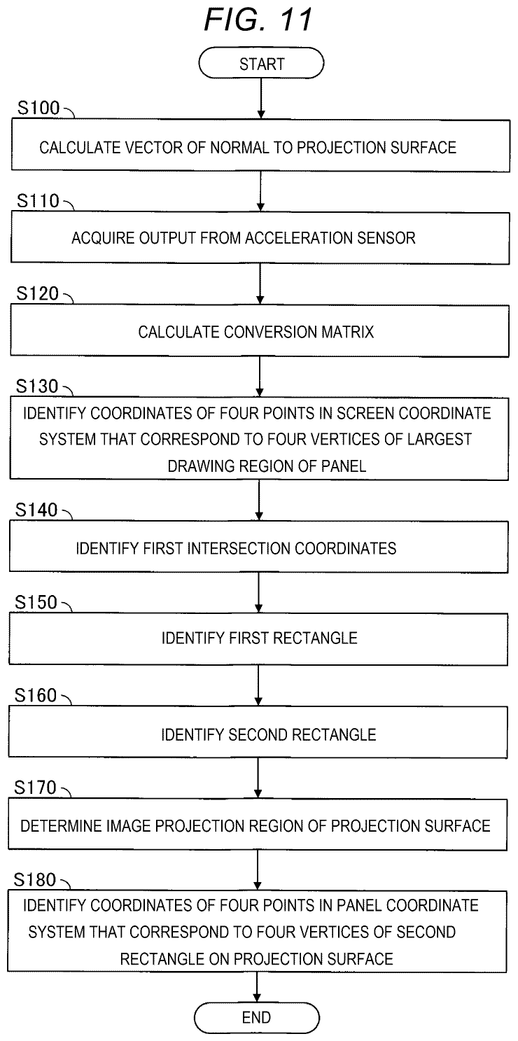

The operation of the projector 100 for suppressing distortion produced in an image projected onto the projection surface SC will next be described with reference to FIG. 11.

FIG. 11 is a flowchart showing an example of the operation of the projector 100. FIG. 11 shows the operation of the projector 100 for suppressing distortion produced in an image projected onto the projection surface SC. The timing at which the operation shown in FIG. 11 is performed is not limited to a specific timing, but the operation is preferably performed when the projector 100 is used for the first time or when the relative positional relationship between the projector 100 and the projection surface SC is changed.

The process in each step shown in FIG. 11 is carried out by the processing device 120 provided in the projector 100.

First, in step S100, the processing device 120 functions as the vertex coordinate identification section 122 and calculates the normal vector n with respect to the projection surface SC. For example, the vertex coordinate identification section 122 acquires, from the distance sensor 180, information representing the distance from the projector 100 to each of multiple locations on the projection surface SC. The vertex coordinate identification section 122 then calculates the normal vector n with respect to the projection surface SC based on the depth map of the projection surface SC based on the distances from the projector 100 to the multiple locations on the projection surface SC.

Thereafter, in step S110, the processing device 120 functions as the vertex coordinate identification section 122 and acquires the output from the acceleration sensor 170. For example, the output from the acceleration sensor 170 is information representing the gravity vector g.

Thereafter, in step S120, the processing device 120 functions as the vertex coordinate identification section 122 and calculates the conversion matrix Aps, which converts the coordinate system from the panel coordinate system EP to the screen coordinate system ES, by using the gravity vector g and the normal vector n.

Thereafter, in step S130, the processing device 120 functions as the vertex coordinate identification section 122 and identifies the coordinates, in the screen coordinate system ES, of four points corresponding to the four vertices P10p, P11p, P12p, and P13p of the largest drawing region DAR1 of the panel PL. For example, the vertex coordinate identification section 122 identifies the coordinates, in the screen coordinate system ES, of the four vertices P10s, P11s, P12s, and P13s corresponding in the one-to-one relationship to the four vertices P10p, P11p, P12p, and P13p. Specifically, the vertex coordinate identification section 122 calculates the coordinates of the vertices P10s, P11s, P12s, and P13s in the screen coordinate system ES based on the product of the coordinates of the vertices P10p, P11p, P12p, and P13p in the panel coordinate system EP and the conversion matrix Aps.

Thereafter, in step S140, the processing device 120 functions as the intersection coordinate identification section 124 and identifies the first intersection coordinates. For example, the intersection coordinate identification section 124 identifies the first intersection coordinates, which are the coordinates of the first intersection PI1s in the screen coordinate system ES, where the two diagonals of the quadrangle QU10s having the four vertices P10s, P11s, P12s, and P13s intersect with each other.

Thereafter, in step S150, the processing device 120 functions as the rectangle identification section 126 and identifies the first rectangle RE1s. For example, the rectangle identification section 126 identifies as the first rectangle RE1s a rectangle that has a center at the first intersection coordinates, has the first aspect ratio, and is the largest but does not protrude from the quadrangle QU10s.

Thereafter, in step S160, the processing device 120 functions as the rectangle identification section 126 and identifies the second rectangle RE2s. For example, the rectangle identification section 126 identifies as the second rectangle RE2s a rectangle that has four vertices one of which is a point where the quadrangle QU10s and the first rectangle RE1s are contact with each other, has the first aspect ratio, and is the largest but does not protrude from the quadrangle QU10s.

Thereafter, in step S170, the processing device 120 functions as the projection region determination section 128 and determines the image projection region PAR of the projection surface SC. For example, the projection region determination section 128 determines the region defined by the second rectangle RE2s as the projection region PAR. Note that since the second rectangle RE2s is identified based on the first rectangle RE1s, determining the projection region PAR based on the first rectangle RE1s includes determining the region defined by the second rectangle RE2s as the projection region PAR.

Thereafter, in step S180, the processing device 120 functions as the vertex coordinate identification section 122 and identifies the coordinates of four points in the panel coordinate system EP that correspond to the four vertices P20s, P21s, P22s, and P23s of the second rectangle RE2s on the projection surface SC. For example, the vertex coordinate identification section 122 identifies the coordinates of the four vertices P20p, P21p, P22p, and P23p in the panel coordinate system EP, which correspond in the one-to-one relationship to the four vertices P20s, P21s, P22s, and P23s. Specifically, the vertex coordinate identification section 122 calculates the coordinates of the vertices P20p, P21p, P22p, and P23p in the panel coordinate system EP based on the product of the coordinates of the vertices P20s, P21s, P22s, and P23s in the screen coordinate system ES and the inverse matrix Aps⁻¹ of the conversion matrix Aps. The drawing region DAR2 of the panel PL is defined by the quadrangle QU2p having the four vertices P20p, P21p, P22p, and P23p.

As described above, in the present embodiment, the image drawing region of each of the panels PL is so corrected to the drawing region DAR2 that the image projection region PAR of the projection surface SC is rectangular. For example, the projector 100 draws an image based on the image data IMG in the drawing region DAR2 of the panel PL. The projector 100 then projects the image drawn in the drawing region DAR2 onto the projection surface SC. The image drawn in the drawing region DAR2 thus appears as a projection image in the projection region PAR defined by the second rectangle RE2s. That is, a corrected rectangular projection image appears on the projection surface SC.

Note that the operation of the projector 100 is not limited to that in the example shown in FIG. 11. For example, the process in step S110 may be carried out before the process in step S100 or may be carried out in parallel with the process in step S100. For example, the process in step S160 may be omitted. In the aspect in which the process in step S160 is omitted, for example, the projection region determination section 128 may determine in step S170 the region defined by the first rectangle RE1s as the projection region PAR. Furthermore, the process in step S180 may be carried out by a functional block other than the projection region determination section 128. For example, the process in step S180 may be carried out by the vertex coordinate identification section 122. Instead, the processing device 120 may function as a functional block other than the vertex coordinate identification section 122, the intersection coordinate identification section 124, the rectangle identification section 126, and the projection region determination section 128 to carry out the process in step S180.

As described above, in the present embodiment, the projector 100 includes the panels PL each having the drawing region DAR1, where an image is drawn, the vertex coordinate identification section 122, the intersection coordinate identification section 124, the rectangle identification section 126, and the projection region determination section 128. The method for determining the projection region PAR according to the present embodiment is a method for determining the projection region PAR, where an image drawn in the drawing region DAR1 of each of the panels PL provided in the projector 100 is projected. In the method for determining the projection region PAR, the vertex coordinate identification section 122 identifies the coordinates of the four vertices P10p, P11p, P12p, and P13p of the rectangle RE10p in the coordinate system of the panels PL, which defines the drawing region DAR1, the coordinates identified in the screen coordinate system ES, which is the coordinate system of the projection surface SC, on which an image is projected and which is viewed in the direction of a normal to the projection surface SC; the intersection coordinate identification section 124 identifies the first intersection coordinates, which are the coordinates, in the screen coordinate system ES, of the first intersection PI1s, where the two diagonals of the quadrangle QU10s corresponding to the rectangle RE10p and having the four vertices P10p, P11p, P12p, and P13p corresponding in a one-to-one relationship to the four vertices P10s, P11s, P12s, and P13s intersect with each other, based on the coordinates of the four vertices P10s, P11s, P12s, and P13s of the quadrangle QU10s; the rectangle identification section 126 identifies as the first rectangle RE1s the largest rectangle that falls within the quadrangle QU10s, has central coordinates equal to the first intersection coordinates, and has the first aspect ratio; and the projection region determination section 128 determines the projection region PAR of the projection surface SC based on the first rectangle RE1s.

As described above, in the present embodiment, the projection region PAR of the projection surface SC is determined based on the first rectangle RE1s having a center at the first intersection coordinates, which are the coordinates of the first intersection PI1s in the screen coordinate system ES. The first rectangle RE1s is the largest rectangle that falls within the quadrangle QU10s on the projection surface SC, which corresponds to the rectangle RE10p, which defines the drawing region DAR1 of each of the panela PL, has a center at the first intersection coordinates, and has the first aspect ratio. Therefore, in the present embodiment, a rectangle that defines the corrected image projection region PAR, which allows effective use of the drawing region DAR1 of each of the panels PL, can be identified. Therefore, in the present embodiment, the drawing region DAR1 of each of the panels PL provided in the projector 100 can be effectively used.

In the present embodiment, the rectangle identification section 126 identifies, as the second rectangle RE2s, which falls within the quadrangle QU10s and is larger than the first rectangle RE1s, a rectangle having four vertices one of which is a point where the quadrangle QU10s and the first rectangle RE1s are in contact with each other and having the first aspect ratio. The projection region determination section 128 determines the projection region PAR of the projection surface SC based on the second rectangle RE2s. As described above, in the present embodiment, the projection region PAR of the projection surface SC is determined based on the second rectangle RE2s larger than the first rectangle RE1s. Therefore, in the present embodiment, the drawing region DAR1 of each of the panels PL can be used more effectively.

In the present embodiment, the coordinates of the four vertices P10s, P11s, P12s, and P13s in the screen coordinate system ES are identified based on the conversion matrix Aps, which associates the panel coordinate system EP, which is the coordinate system of the panels PL, with the screen coordinate system ES. Therefore, in the present embodiment, the coordinates, in the screen coordinate system ES, of the four vertices P10s, P11s, P12s, and P13s of the quadrangle QU10s, which defines a region of the projection surface SC that corresponds to the drawing region DAR1 of each of the panels PL, can be identified without using a high-resolution sensor that detects the region.

In the present embodiment, the conversion matrix Aps is calculated based on the gravity vector g based on the output from the acceleration sensor 170 associated with the panel coordinate system EP, and the normal vector n with respect to the projection surface SC. Therefore, in the present embodiment, the conversion matrix Aps in consideration of inclination of the projector 100 with respect to the ground can be calculated. For example, in the present embodiment, the Xs-axis of the screen coordinate system ES can be made parallel to the horizontal plane irrespective of the inclination of the projector 100 with respect to the ground. Therefore, in the present embodiment, the user can view an upright projection image with respect to the ground when viewed from the user irrespective of the inclination of the projector 100 with respect to the ground.

In the present embodiment, the normal vector n with respect to the projection surface SC is calculated based on the depth map of the projection surface SC based on the output from the distance sensor 180, which detects the distance. Therefore, in the present embodiment, the user's time and effort for visually measuring the normal vector n can be eliminated.

### 2. VARIATIONS

The embodiment described above can be changed in various manners. Specific aspects of the variations will be presented below by way of example. Two or more aspects randomly selected from the following examples can be combined with each other as appropriate to the extent that the selected aspects do not contradict each other. In the variations presented below by way of example, elements having effects and functions that are the same as those in the embodiment have the same reference characters referred to in the above description, and no detailed description of the same elements will be made as appropriate.

### First Variation

In the embodiment described above, the case where the first rectangle RE1s is identified is presented by way of example, but the present disclosure is not limited to such an aspect. For example, the rectangle identification section 126 may identify the second rectangle RE2s without identifying the first rectangle RE1s.

In the present variation, the vertex coordinate identification section 122 identifies the coordinates of the four vertices P10s, P11s, P12s, and P13s in the screen coordinate system ES, as in the embodiment described above. The intersection coordinate identification section 124 further identifies the first intersection coordinates, as in the embodiment described above. The rectangle identification section 126 then identifies as the reference point a point where the largest rectangle that falls within the quadrangle QU10s, has a center at the first intersection coordinates, and has the first aspect ratio is in contact with the quadrangle QU10s. The rectangle identification section 126 further identifies as the second rectangle RE2s the largest rectangle that falls within the quadrangle QU10s, has four vertices one of which is the reference point, and has the first aspect ratio. The projection region determination section 128 then determines the projection region PAR of the projection surface SC based on the second rectangle RE2s. Note that the largest rectangle that falls within the quadrangle QU10s, has a center at the first intersection coordinates, and has the first aspect ratio corresponds to the first rectangle RE1s, but the reference point can be instead identified without identifying the first rectangle RE1s, as described with reference to FIG. 8.

As described above, the present variation can also provide advantages that are the same as those provided by the embodiment described above. Furthermore, in the present variation, since identifies the second rectangle RE2s is identified without identifying the first rectangle RE1s, the processing load on the processing device 120 in the process of determining the projection region PAR of the projection surface SC can be reduced.

### Second Variation

The aforementioned embodiment has been described with reference to the case where the conversion matrix Aps is calculated by using the gravity vector g and the normal vector n, but the present disclosure is not limited to such an aspect. For example, a vector representing the direction along the Yp-axis of the panel coordinate system EP may be used in place of the gravity vector g. That is, the conversion matrix Aps may be calculated by using a vector representing the direction along the Yp-axis of the panel coordinate system EP and the normal vector n.

The present variation described above can also provide advantages that are the same as those provided by the embodiment described above except for the advantages provided by calculating the conversion matrix Aps by using the gravity vector g. The advantage provided by calculating the conversion matrix Aps by using the gravity vector g is, for example, an advantage of making the Xs-axis of the screen coordinate system ES parallel to the horizontal plane irrespective of inclination of the projector 100 with respect to the ground. Note, for example, that when the inclination of the projector 100 with respect to the ground is small enough not to affect the user's visibility, the user can view also in the present variation an upright projection image with respect to the ground or a substantially upright projection image with respect to the ground. In the present variation, the projector 100 may not include the acceleration sensor 170.

### 3. ADDITIONAL REMARKS

From the embodiment and variations described above by way of example, for example, the configurations below are grasped.

A method for determining a projection region according to a first aspect, which is a preferable aspect, is a method for determining a projection region in which an image drawn in a drawing region of a panel provided in a projection apparatus is projected, the method including: identifying coordinates of four vertices of a first quadrangle that defines the drawing region in a coordinate system of the panel, the coordinates being identified in a first coordinate system that is a coordinate system of a projection surface on which the image is projected and which is viewed in a direction of a normal to the projection surface; identifying first intersection coordinates that are coordinates, in the first coordinate system, of a point where two diagonals of a second quadrangle corresponding to the first quadrangle and having four vertices corresponding in a one-to-one relationship to the four vertices of the first quadrangle intersect with each other based on coordinates of the four vertices of the second quadrangle; identifying as a first rectangle a largest rectangle that falls within the second quadrangle, has central coordinates equal to the first intersection coordinates, and has a first aspect ratio; and determining the projection region of the projection surface based on the first rectangle.

According to the first aspect, a rectangle that defines the corrected image projection region, which allows effective use of the drawing region of the panel, can be identified. Therefore, in the present aspect, the drawing region of the panel provided in the projection apparatus can be effectively used.

The method for determining a projection region according to a second aspect, which is a specific example of the first aspect, further includes identifying, as a second rectangle that falls within the second quadrangle and is larger than the first rectangle, a rectangle having four vertices one of which is a point where the second quadrangle and the first rectangle are in contact with each other and having the first aspect ratio, and the projection region of the projection surface is determined based on the second rectangle.

According to the second aspect, the projection region of the projection surface is determined based on the second rectangle larger than the first rectangle. Therefore, in the present aspect, the drawing region of the panel can be more effectively used.

A method for determining a projection region according to a third aspect, which is a preferable aspect, is a method for determining a projection region in which an image drawn in a drawing region of a panel provided in a projection apparatus is projected, the method including: identifying coordinates of four vertices of a first quadrangle that defines the drawing region in a coordinate system of the panel, the coordinates being identified in a first coordinate system that is a coordinate system of a projection surface on which the image is projected and which is viewed in a direction of a normal to the projection surface; identifying first intersection coordinates that are coordinates, in the first coordinate system, of a point where two diagonals of a second quadrangle corresponding to the first quadrangle and having four vertices corresponding in a one-to-one relationship to the four vertices of the first quadrangle intersect with each other based on coordinates of the four vertices of the second quadrangle; identifying as a reference point a point where a largest rectangle that falls within the second quadrangle, has central coordinates equal to the first intersection coordinates, and has a first aspect ratio is in contact with the second quadrangle; identifying as a second rectangle a rectangle that falls within the second quadrangle, has four vertices one of which is the reference point, and has the first aspect ratio; and determining the projection region of the projection surface based on the second rectangle.

The third aspect can provide advantages that are the same as those provided by the second aspect.

In the method for determining a projection region according to a fourth aspect, which is a specific example of any one of the first to third aspects, the coordinates of the four vertices in the first coordinate system are identified based on a correspondence that associates a second coordinate system that is the coordinate system of the panel with the first coordinate system.

According to the fourth aspect, the coordinates, in the first coordinate system, of the four vertices of the second quadrangle, which defines a region of the projection surface that corresponds to the drawing region of the panel, can be identified without using a high-resolution sensor that detects the region.

In the method for determining a projection region according to a fifth aspect, which is a specific example of the fourth aspect, the correspondence is calculated based on a gravity vector based on an output from an acceleration sensor associated with the second coordinate system, and a vector of a normal to the projection surface.

According to the fifth aspect, a correspondence in consideration of inclination of the projection apparatus with respect to the ground can be calculated as the correspondence that associates the second coordinate system with the first coordinate system.

In the method for determining a projection region according to a sixth aspect, which is a specific example of the fifth aspect, the vector of a normal to the projection surface is calculated based on a depth map of the projection surface based on an output from a distance sensor configured to detect a distance.

According to the sixth aspect, the user's time and effort for visually measuring the normal vector can be eliminated.

A projection apparatus according to a seventh aspect, which is a preferable aspect, includes a panel having a drawing region in which an image is drawn; and a processing circuit, the processing circuit is configured to identify coordinates of four vertices of a first quadrangle that defines the drawing region in a coordinate system of the panel, the coordinates being identified in a first coordinate system that is a coordinate system of a projection surface on which the image is projected and which is viewed in a direction of a normal to the projection surface; identify first intersection coordinates that are coordinates, in the first coordinate system, of a point where two diagonals of a second quadrangle corresponding to the first quadrangle and having four vertices corresponding in a one-to-one relationship to the four vertices of the first quadrangle intersect with each other based on coordinates of the four vertices of the second quadrangle; identify as a first rectangle a largest rectangle that falls within the second quadrangle, has central coordinates equal to the first intersection coordinates, and has a first aspect ratio; and determine a projection region of the projection surface based on the first rectangle, the projection region being a region where the image is projected.

The seventh aspect can provide advantages that are the same as those provided by the first aspect.

What is claimed is:

1. A method for determining a projection region in which an image drawn in a drawing region of a panel disposed in a projection apparatus is projected, the method comprising:
identifying coordinates that are in a first coordinate system, for each of four vertices of a first quadrangle that defines the drawing region in a coordinate system of the panel, the first coordinate system being a coordinate system of a projection surface on which the image is projected and which is viewed in a direction of a normal to the projection surface;
identifying first intersection coordinates that are in the first coordinate system and that are coordinates of a point where two diagonals of a second quadrangle intersect with each other based on coordinates for each of four vertices of the second quadrangle, the second quadrangle corresponding to the first quadrangle, and the four vertices of the second quadrangle corresponding in a one-to-one relationship to the four vertices of the first quadrangle;
identifying as a first rectangle a largest rectangle that falls within the second quadrangle, has central coordinates equal to the first intersection coordinates, and has a first aspect ratio; and
determining the projection region of the projection surface based on the first rectangle.

2. The method for determining a projection region according to claim 1, further comprising
identifying, as a second rectangle that falls within the second quadrangle and is larger than the first rectangle, a rectangle having four vertices one of which is a point where the second quadrangle and the first rectangle are in contact with each other and having the first aspect ratio,
wherein the projection region of the projection surface is determined based on the second rectangle.

3. The method for determining a projection region according to claim 1,
wherein the coordinates for each of the four vertices in the first coordinate system are identified based on a correspondence that associates a second coordinate system that is the coordinate system of the panel with the first coordinate system.

4. The method for determining a projection region according to claim 3,
wherein the correspondence is calculated based on a gravity vector based on an output from an acceleration sensor associated with the second coordinate system, and a vector of a normal to the projection surface.

5. The method for determining a projection region according to claim 4,
wherein the vector of a normal to the projection surface is calculated based on a depth map of the projection surface based on an output from a distance sensor configured to detect a distance.

6. A projection apparatus comprising:
a panel having a drawing region in which an image is drawn; and
a processing circuit,
wherein the processing circuit is configured to identify coordinates that are in a first coordinate system, for each of four vertices of a first quadrangle that defines the drawing region in a coordinate system of the panel, the first coordinate system being a coordinate system of a projection surface on which the image is projected and which is viewed in a direction of a normal to the projection surface;
identify first intersection coordinates that are in the first coordinate system and that are coordinates, of a point where two diagonals of a second quadrangle intersect with each other based on coordinates for each of four vertices of the second quadrangle, the second quadrangle corresponding to the first quadrangle, and the four vertices of the second quadrangle corresponding in a one-to-one relationship to the four vertices of the first quadrangle;
identify as a first rectangle a largest rectangle that falls within the second quadrangle, has central coordinates equal to the first intersection coordinates, and has a first aspect ratio; and
determine a projection region of the projection surface based on the first rectangle, the projection region being a region where the image is projected.
